(19) United States
(12) Patent Application Publication
(10) Pub. No.: US 2012/0146813 A1
(43) Pub. Date: Jun. 14, 2012

(54) EMERGENCY BEACON AND SYSTEM

(76) Inventor: James C. Gilmore, Long Beach, MS (US)

(21) Appl. No.: 12/966,197

(22) Filed: Dec. 13, 2010

(51) Int. Cl. G08G 1/095; G08C 19/12; G09F 9/33; G08B 5/00

(52) U.S. Cl. 340/907; 340/815.4; 340/13.25; 340/815.45

(57) ABSTRACT

An emergency beacon includes a housing with a first open space and a second open space. A battery and electronics circuitry are received in the housing. The electronics circuitry includes an r.f. illumination control circuit and a power supply circuit. The r.f. illumination control circuit is configured to receive an r.f. activation signal. A solar panel is electrically coupled to the power supply circuit for charging the battery. A first closure member is received to close the first open space of the housing. A second closure member is received to close the second open space of the housing. A beacon light source is mounted to the second closure member. The r.f. illumination control circuit is configured to activate the beacon light source to emit light upon receiving the r.f. activation signal.

### CROSS-REFERENCE TO RELATED APPLICATIONS

None.

### BACKGROUND OF THE INVENTION

1. Field of the Invention

The present invention relates to emergency warning systems, and, more particularly, to an emergency beacon and emergency evacuation beacon system.

2. Description of the Related Art

During an emergency evacuation, such as due to the approach of a hurricane, the public may be requested to evacuate a particular geographic region, such as a coastal region. Such an evacuation notification typically occurs by broadcast of information from television and radio media. Often, a predetermined evacuation route is designated by signs, and at times, intersections may be manned by personnel from a government agency. Sometimes, however, it may be difficult for the public to identify from a distance which way to go to get on the evacuation route. Finding the evacuation route may be particularly difficult during storm conditions (e.g., heavy rain that may be accompanied by strong wind), or if the electrical power has been interrupted, thereby putting traffic signals and the like out of commission.

### SUMMARY OF THE INVENTION

The present invention provides an emergency beacon and an emergency evacuation beacon system, to aid the public in evacuating a geographic region in the event of a public emergency.

The invention, in one form thereof, is directed to an emergency beacon. The emergency beacon includes a housing having a first end, a second end, and a side wall extending between the first end and the second end. The housing has a first open space adjacent the first end and a second open space adjacent the second end. A battery is received in the housing. Electronics circuitry is received in the housing. The electronics circuitry is electrically coupled to the battery. The electronics circuitry includes an r.f. illumination control circuit and a power supply circuit. The r.f. illumination control circuit is configured to receive an r.f. activation signal. A solar panel is electrically coupled to the power supply circuit for charging the battery. A first closure member is received at the first end to close the first open space of the housing. A second closure member is received at the second end to close the second open space of the housing. A beacon light source is mounted to the second closure member. The second closure member is configured to facilitate an electrical connection between the beacon light source and the r.f. illumination control circuit. The r.f. illumination control circuit is configured to activate the beacon light source to emit light upon receiving the r.f. activation signal.

The invention, in another form thereof, is directed to an emergency evacuation beacon system for use along a predetermined evacuation route during an evacuation of a geographic region. The emergency evacuation beacon system includes a plurality of r.f. controlled emergency beacons located along the predetermined evacuation route. Each emergency beacon has a respective beacon light source. Each emergency beacon of the plurality of r.f. controlled emergency beacons is responsive to an activation signal on a particular predetermined radio frequency to activate the respective beacon light source. At least two emergency beacons of the plurality of r.f. controlled emergency beacons respond to the same predetermined radio frequency.

The invention, in still another form thereof, is directed to an emergency beacon with remote control. The emergency beacon includes a housing. A rechargeable battery is received in the housing. Electronics circuitry is received in the housing. The electronics circuitry includes a power supply circuit and an r.f. illumination control circuit. The power supply circuit is electrically coupled to the rechargeable battery. The r.f. illumination control circuit is configured to receive an r.f. activation signal. A solar panel is mounted to an exterior surface of the housing. The solar panel is electrically coupled to the power supply circuit for charging the battery. A beacon light source is mounted to the housing. The beacon light source is electrically coupled to the r.f. illumination control circuit. The r.f. illumination control circuit is configured to activate the beacon light source to emit light upon receiving the r.f. activation signal. A wireless remote control transmitter is configured to generate the r.f. activation signal. The wireless remote control transmitter is configured to communicate the r.f. activation signal to the r.f. illumination control circuit on a predetermined frequency.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a front view of an emergency beacon configured in accordance with an embodiment of the present invention;

FIG. 2 is a back exploded view of the emergency beacon of FIG. 1, and showing interior open spaces by phantom lines;

FIG. 3 illustrates an exemplary mounting of the emergency beacon of FIG. 1 to an elevated structure, such as a street light pole;

FIG. 4 is illustrates another exemplary mounting of the emergency beacon of FIG. 1 using a side mounting bracket;

FIG. 5 is an electrical block diagram of the emergency beacon of FIG. 1;

FIG. 6 illustrates with respect to a geographic region, e.g., a coastal region, an emergency evacuation beacon system for use along a predetermined evacuation route; and

FIG. 7 shows a diagram of the emergency evacuation beacon system of FIG. 6.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

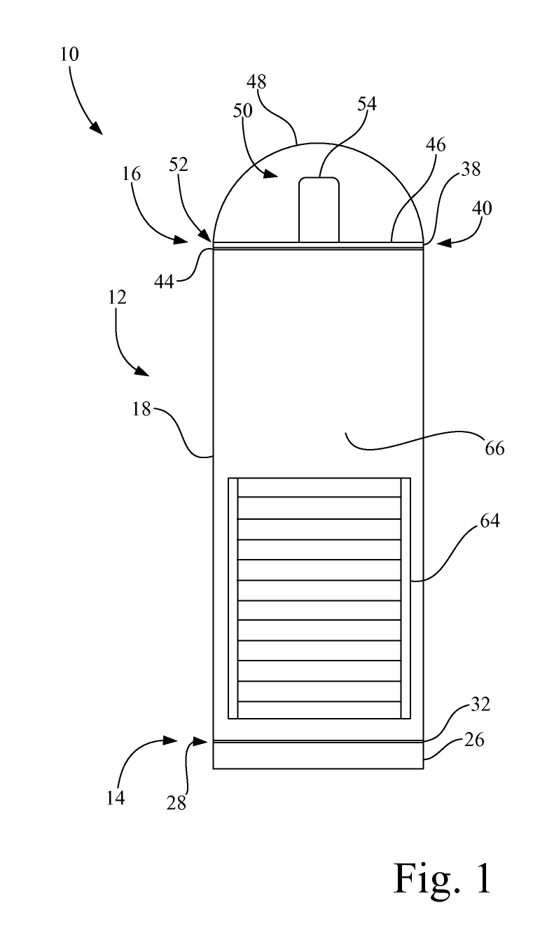

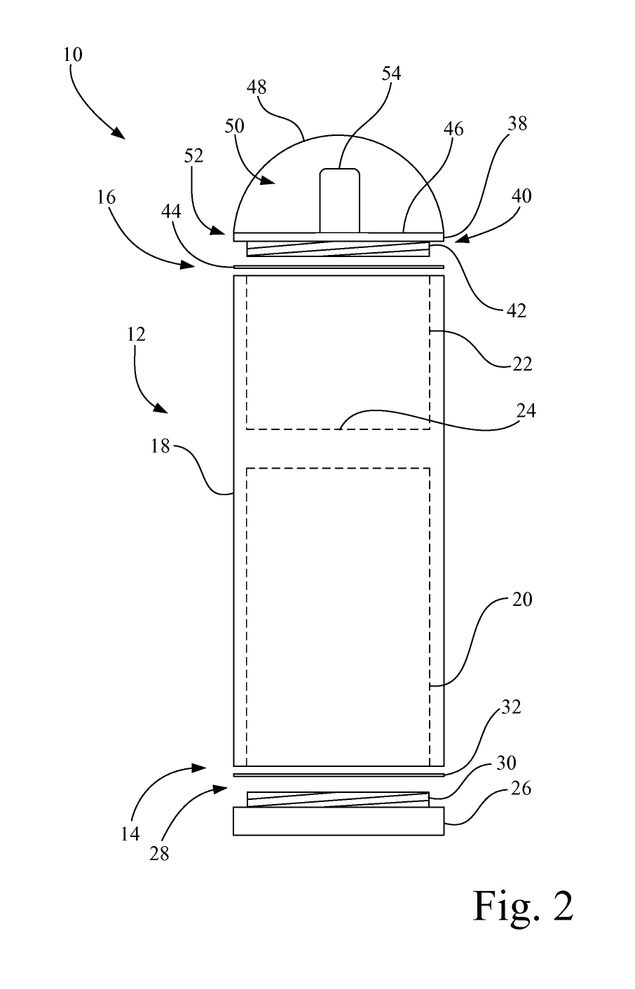

Referring now to the drawings and particularly to FIGS. 1 and 2, there is shown an emergency beacon 10 configured in accordance with an embodiment of the present invention.

Emergency beacon 10 has a housing 12 having a first end 14, a second end 16, and a side wall 18 extending between first end 14 and second end 16. Housing 12 has a first open space 20 adjacent first end 14 and a second open space 22 adjacent second end 16. In the present embodiment, an optional separator wall 24 (shown by dashed lines) is provided to separate first open space 20 from second open space 22 to form two chambers. However, it is contemplated that in an alternative embodiment separator wall 24 may be eliminated such that first open space 20 and second open space 22 form a continuous chamber.

In the present embodiment, side wall 18 is a cylindrical tube that is made from an ultraviolet light (UV) resistant polyvinyl chloride (PVC) material. Side wall 18 may have a thickness of 0.125 to 0.25 inches. Side wall 18 may have a length about three times the width (e.g., diameter), such as for example, 12 inches in length and 4 inches in width (diameter).

A first closure member 26 is received at first end 14 to close first open space 20 of housing 12. In the present embodiment, first closure member 26 is made from an ultraviolet light (UV) resistant polyvinyl chloride (PVC) material. In the present embodiment, first end 14 of housing 12 is connected to first closure member 26 by a first threaded coupling 28, e.g., with first end 14 having internal threads (not shown) to receive complementary external threads 30 of first closure member 26. A first sealing member 32 is interposed between first end 14 of housing 12 and first closure member 26 to provide waterproofing at the juncture of first end 14 of housing 12 and first closure member 26. Alternatively, first sealing member 32 may be provided by applying a flowable sealing material, such as silicone caulk or silicone rubber, at first threaded coupling 28.

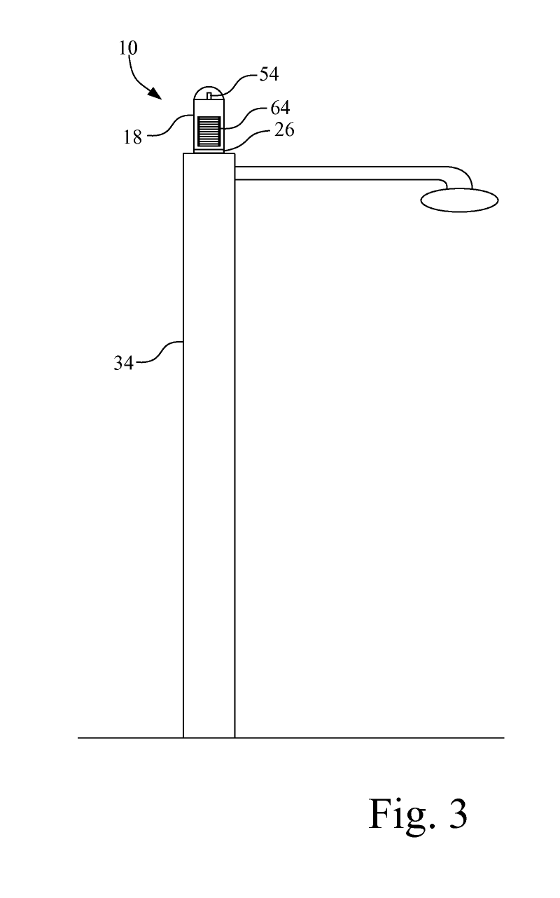

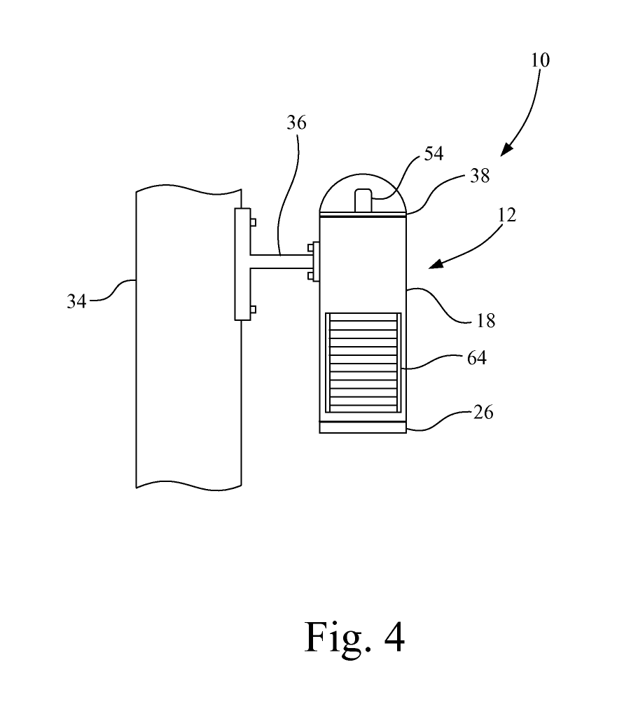

Referring to FIG. 3, first closure member 26 of emergency beacon 10 is configured to serve as a base support for mounting emergency beacon 10 to a secondary structure, i.e., an elevated structure 34, such as a street light pole, traffic signal pole, tower, building, etc. The mounting of first closure member 26 to elevated structure 34 may be, for example, by bolts (not shown) extending through first closure member 26 and into respective apertures associated with elevated structure 34. Alternatively, as shown in FIG. 4, a mounting bracket 36 may be attached to side wall 18 for mounting emergency beacon 10 to secondary structure i.e., an elevated structure 34, such as a street light pole, traffic signal pole, tower, building, etc. Attachment of mounting bracket 36 to emergency beacon 10 and/or elevated structure 34 may be made, for example, bolts, straps, or a combination thereof.

Referring again to FIGS. 1 and 2, a second closure member 38 is received at second end 16 to close second open space 22 of housing 12. In the present embodiment, second closure member 38 is made from an ultraviolet light (UV) resistant polyvinyl chloride (PVC) material. In the present embodiment, second end 16 of housing 12 is connected to second closure member 38 by a second threaded coupling 40, e.g., with second end 16 having internal threads (not shown) to receive complementary external threads 42 of second closure member 38. A second sealing member 44 is interposed between second end 16 of housing 12 and second closure member 38 to provide waterproofing at the juncture of second end 16 of housing 12 and second closure member 38. Alternatively, second sealing member 44 may be provided by applying a flowable sealing material, such as silicone caulk or silicone rubber, at second threaded coupling 40.

The second closure member 38 includes a base 46 and a transparent cover 48. Transparent cover 48 may be made, for example, from a transparent plastic (e.g., clear or tinted) that is molded into a dome shape. Transparent cover 48 is coupled to base 46 to define a beacon chamber 50 between base 46 and transparent cover 48, with beacon chamber 50 being made to be waterproof by using appropriate seals or sealants. The coupling of transparent cover 48 to base 46 may be by a threaded coupling 52.

A beacon light source 54 is mounted to second closure member 38 in beacon chamber 50, and more particularly, is mounted to base 46. Beacon light source 54 is selected to have electrical and/or illumination characteristics to provide a luminous intensity (e.g., light output) that is visible to a human observer at distances of one-quarter of a mile or greater, and more preferably, at distances of one mile or greater. In the present exemplary embodiment, the color of the light output is yellow. In the case of a white-light output of beacon light source 54, transparent cover 48 may be tinted to provide the desired output color, e.g., yellow. Alternatively, tinted lens or covers may be interposed between beacon light source 54 and transparent cover 48 to provide the desired color of the light output.

The beacon light source 54 may be, for example, a stationary multifaceted light emitting diode (LED) array that is omnidirectional, providing 360 degree visibility, with each facet having a plurality of individual LEDs arranged in an array. With the multifaceted light emitting diode (LED) array, each facet is electronically controlled (e.g., gated ON and OFF) to provide a pulsating light output appearance to a human observer. Each LED array may include for example, 3 to 20 individual LEDs per facet, arranged in a generally linear, circular, oval or rectangular pattern on each facet. Each LED may have a power consumption, for example, of about 50 to 100 milliwatts. Alternatively, beacon light source 54 may be a rotating light source that is formed using one or more LED arrays, one or more incandescent bulbs, one or more excited gas (e.g., fluorescent) bulbs, etc., and rotated by a motorized rotation mechanism that is controlled to provide a pulsating light output appearance to the human observer.

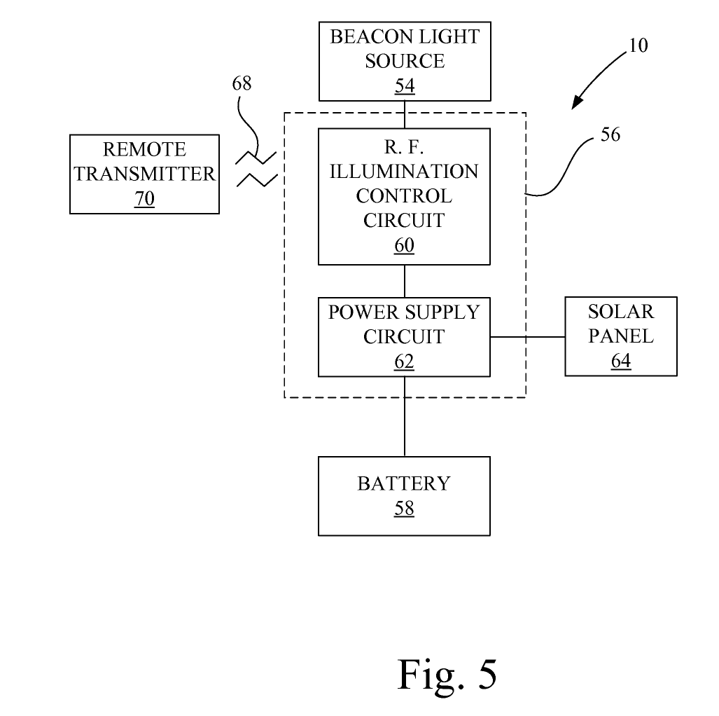

Referring to FIG. 5, beacon light source 54 is controlled by electronics circuitry 56 and powered by a battery 58, e.g., a rechargeable battery. In the present embodiment, referring also to FIG. 2, battery 58 is mounted in housing 12, and more particularly, in first open space 20 (i.e., first chamber), on side wall 18 or on separator wall 24. Battery 58 is accessed by removing first closure member 26 from housing 12. Also, electronics circuitry 56 is mounted in housing 12, and more particularly, in second open space 22 (i.e., second chamber) on side wall 18 or on separator wall 24. Electronics circuitry 56 is accessed by removing second closure member 38 from housing 12.

Electronics circuitry 56 is electrically coupled to battery 58. The electrical coupling of electronics circuitry 56 to battery 58 may be, for example, by electrical wiring/cabling and/or a printed circuit. In embodiments that include separator wall 24 (see FIG. 2), separator wall 24 is configured to accommodate the electrical coupling, such as by providing a hole that connects first open space 20 to second open space 22 through which the electrical wiring/cabling and/or printed circuit is passed. The hole may be sealed by a sealant, such as a silicone caulk or silicone rubber, to maintain a waterproof separation of first open space 20 (first chamber) and second open space 22 (second chamber).

Battery 58 is preferably a rechargeable battery, and may be a rechargeable battery pack formed by a plurality of rechargeable batteries of a common size, such as D, C, AA or AAA rechargeable batteries. The electrical capacity of battery 58 is selected to provide a predetermined duration of operation of emergency beacon 10. For example, the duration may be in the range or 50 to 250 hours of operation.

Electronics circuitry 56 also is electrically coupled to beacon light source 54. The electrical coupling of electronics circuitry 56 to beacon light source 54 may be, for example, by electrical wiring/cabling and/or a printed circuit. In the present embodiment (see FIG. 2), base 46 of second closure member 38 is configured to accommodate the electrical coupling, such as by providing a hole that connects beacon chamber 50 to second open space 22 (second chamber) through which the electrical wiring/cabling and/or printed circuit is passed. The hole may be sealed by a sealant, such as a silicone caulk or silicone rubber, to maintain a waterproof separation of beacon chamber 50 and second open space 22 (second chamber).

As shown in FIG. 5, electronics circuitry 56 includes a radio frequency (r.f.) illumination control circuit 60 and a power supply circuit 62.

Power supply circuit 62 is electrically coupled to a solar panel 64 for charging battery 58. The electrical coupling of solar panel 64 to power supply circuit 62 may be, for example, by electrical wiring/cabling and/or a printed circuit. Solar panel 64 may be mounted, for example, on an exterior surface 66 of housing 12, such as on side wall 18, as shown in FIG. 1. In the present embodiment, side wall 18 is configured to accommodate the electrical coupling, such as by providing a hole (not shown) to second open space 22 (second chamber) through which the electrical wiring/cabling and/or printed circuit is passed. The hole may be sealed by a sealant, such as a silicone caulk or silicone rubber, to maintain a waterproof separation of second open space 22 (second chamber) from the ambient atmosphere external to housing 12.

Alternatively, solar panel 64 may be formed integral with housing 12 to form a portion of side wall 18 of housing 12, thereby providing direct access to second open space 22 (second chamber) of housing 12 to facilitate connection of solar panel 64 to power supply circuit 62 of electronics circuitry 56.

The r.f. illumination control circuit 60 is electrically connected to battery 58, which may be via power supply circuit 62 or by direct electrical cabling/printed circuit. Also, the r.f. illumination control circuit 60 is electrically connected to beacon light source 54. Second closure member 38 (see FIGS. 1 and 2) is configured to facilitate an electrical connection between beacon light source 54 and r.f. illumination control circuit 60. The electrical coupling of electronics circuitry 56 to beacon light source 54 may be, for example, by electrical wiring/cabling and/or a printed circuit.

The r.f. illumination control circuit 60 may include a combination of analog and digital circuitry, and may include a programmable/tunable frequency module to provide a selection of a desired operation frequency (r.f.), and a microprocessor and/or digital logic circuitry for defining light pulse duration and/or light rotation. The r.f. illumination control circuit 60 is configured to receive an r.f. activation signal 68, and is configured to activate beacon light source 54 to emit light upon receiving r.f. activation signal 68. The r.f. illumination control circuit 60 controls beacon light source 54 via a power output circuit to provide a pulsating light output appearance to a human observer.

A wireless remote control transmitter 70 is used as a user interface to communicate wirelessly with emergency beacon 10 to activate emergency beacon 10, and is considered as an integral part of the emergency beacon system. Wireless remote control transmitter 70 and r.f. illumination control circuit 60 are configured with respective electrical circuitry to communicate on a predetermined radio frequency (r.f.). Wireless remote control transmitter 70 is configured with electrical circuitry to generate r.f. activation signal 68 on the predetermined r.f. frequency, and r.f. illumination control circuit 60 is configured with electrical circuitry to receive r.f. activation signal 68 on the predetermined r.f. frequency. When r.f. illumination control circuit 60 receives r.f. activation signal 68, r.f. illumination control circuit 60 activates beacon light source 54 and beacon light source 54 provide a pulsating light output appearance to a human observer which, in the absence of obstructions, is visible to the public at distances of one-quarter of a mile or greater.

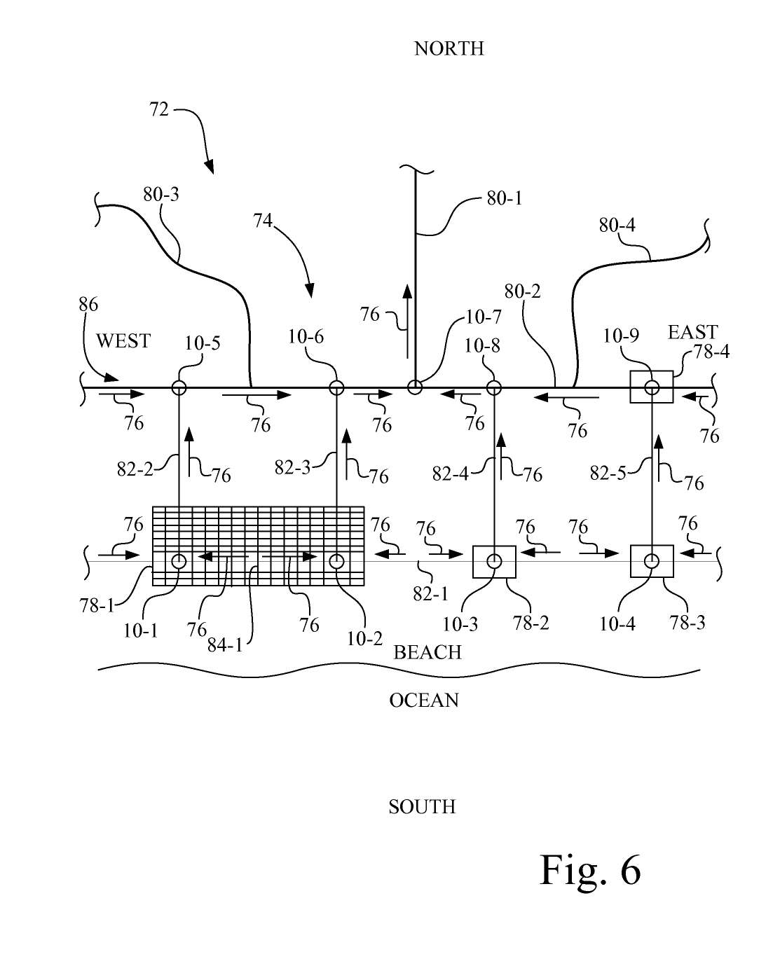

FIG. 6 illustrates with respect to a geographic region 72, e.g., a coastal region, an emergency evacuation beacon system 74 for use along a predetermined evacuation route 76. FIG. 6 is in the form of a map, designating North, South, East and West, and landmarks, such as the beach and the ocean. The predetermined evacuation route 76 is typically designated by local, state and/or federal government agencies, and is illustrated by arrows in FIG. 6. In FIG. 6, to aid the reader in understanding emergency evacuation beacon system 74 of the present invention, each town (or city) is represented a rectangle, designated as towns 78-1, 78-2, 78-3 and 78-4, each emergency beacon 10 is represented as a circle, and individually identified as emergency beacons 10-1, 10-2, 10-3, 10-4, 10-5, 10-6, 10-7, 10-8 and 10-9, and which are referred to collectively as a plurality of r.f. controlled emergency beacons 86. Each major highway 80-1, 80-2, 80-3 and 80-4 is represented by a line that is thicker than the line used to designate each minor highway 82-1, 82-2, 82-3, 82-4, and 82-5. In the region of the Gulf of Mexico, for example, highway 80-1 may represent interstate highway I-56; highway 80-2 may represent interstate highway I-10; highway 80-3 may represent interstate highway I-55; and highway 80-4 may represent interstate highway I-65. City streets 84-1 in town 78-1 are represented by rectangular crosshatching.

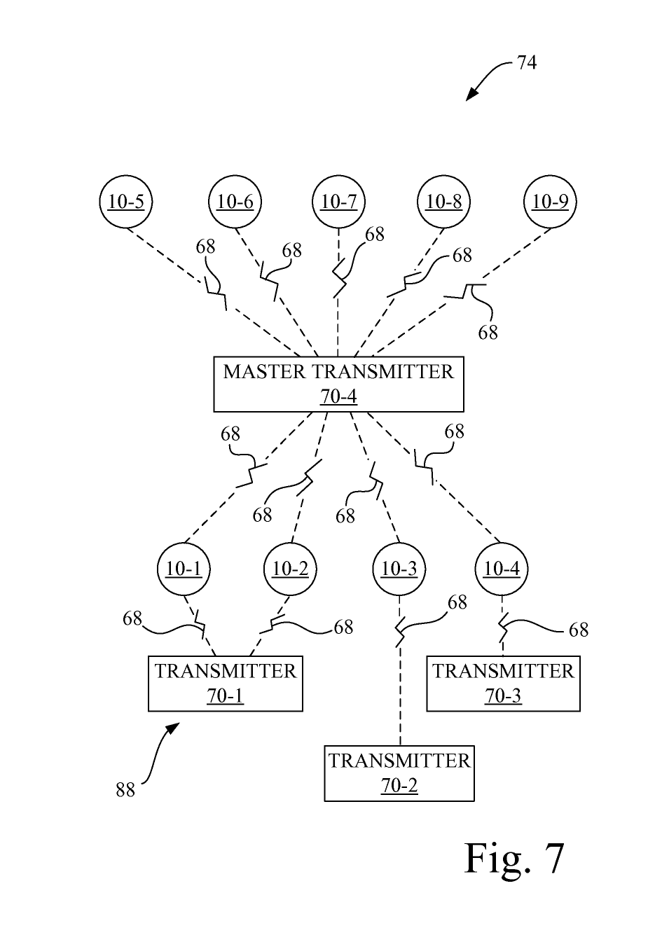

Also, FIG. 7 is a simplified illustration of emergency evacuation beacon system 74, and includes a plurality of exemplary wireless remote control transmitters 70-1, 70-2, 70-3, 70-4 for controlling the activation of all, or a portion, of emergency evacuation beacon system 74, as explained in more detail below.

In the embodiment illustrated in FIG. 6, emergency evacuation beacon system 74 includes the plurality of r.f. controlled emergency beacons 86, including individual emergency beacons 10-1, 10-2, 10-3, 10-4, 10-5, 10-6, 10-7, 10-8 and 10-9, that are located along evacuation route 76, with some of the plurality of r.f. controlled emergency beacons 86 being distributed among the towns 78-1, 78-2, 78-3 and 78-4. Each of at least a portion of the plurality of r.f. controlled emergency beacons 86 is located at a respective road intersection along evacuation route 76. For long stretches of highway, one or more additional r.f. controlled emergency beacons by be located at non-intersection areas of highway to assure the public that they are in fact on evacuation route 76. Each of the plurality of r.f. controlled emergency beacons 86 is mounted on an elevated structure 34 (see, e.g., FIG. 3), such as a street light pole, traffic signal pole, tower, building, to make the plurality of r.f. controlled emergency beacons 86 more visible to the public.

In the present embodiment, each emergency control beacon 10-1, 10-2, 10-3, 10-4, 10-5, 10-6, 10-7, 10-8 and 10-9 of the plurality of r.f. controlled emergency beacons 86 is functionally equivalent, if not identical, to emergency control beacon 10 described above. As such, each emergency beacon 10-1, 10-2, 10-3, 10-4, 10-5, 10-6, 10-7, 10-8 and 10-9 of the plurality of r.f. controlled emergency beacons 86 is responsive to a particular predetermined radio frequency to activate the respective beacon light source 54 of the respective emergency beacon 10-1, 10-2, 10-3, 10-4, 10-5, 10-6, 10-7, 10-8 and 10-9. Typically, at least two emergency beacons of the plurality of r.f. controlled emergency beacons 86 will be configured to respond to the same predetermined radio frequency. More typically, all of a particular grouping of the plurality of r.f. controlled emergency beacons 86, such as those located in a particular town or region, or along a particular evacuation route, e.g., evacuation route 76, will be configured to respond to the same predetermined radio frequency. However, it is contemplated that all of the plurality of r.f. controlled emergency beacons 86 may be controlled for actuation by responding to the same predetermined radio frequency. Also, it is contemplated that a subset of the plurality of r.f. controlled emergency beacons 86 may be configured to be responsive to two or more predetermined radio frequencies.

Referring also to FIG. 7, the plurality of r.f. controlled emergency beacons 86 may be activated by one or more wireless remote control transmitter(s) 70, e.g., individually identified as wireless remote control transmitters 70-1, 70-2, 70-3, 70-4. The remote control transmitters 70-1, 70-2, 70-3, 70-4 may be distributed between the various government agencies and a civil defense organization. As such, each wireless remote control transmitter 70 is configured to generate r.f. activation signal 68 at the proper frequency to activate at least a portion of the plurality of r.f. controlled emergency beacons 86, i.e., some or all of the individual emergency beacons 10 tuned to the same frequency as a respective wireless remote control transmitter 70, in an emergency evacuation situation.

As illustrated in the example of FIG. 7, in some embodiments of the invention, a master wireless remote control transmitter 70-4 is configured to generate r.f. activation signal 68 at the proper frequency to simultaneously activate each and all of the plurality of r.f. controlled emergency beacons 86 in the depicted geographic region 72 when all of the plurality of r.f. controlled emergency beacons 86 (e.g., 10-1, 10-2, 10-3, 10-4, 10-5, 10-6, 10-7, 10-8 and 10-9) are operating on (i.e., tuned to) the same frequency as r.f. activation signal 68 transmitted by wireless remote control transmitter 70-4. Master wireless remote control transmitter 70-4 may be operated, for example, by designated personnel from the Coast Guard. Also, as illustrated in FIG. 7, r.f. controlled emergency beacons 10-1 and 10-2 may be operatively configured to also respond to r.f. activation signal 68 at the frequency generated by wireless remote control transmitter 70-1. Further, r.f. controlled emergency beacon 10-3 may be operatively configured to also respond to r.f. activation signal 68 at the frequency generated by wireless remote control transmitter 70-2, and r.f. controlled emergency beacon 10-4 may be operatively configured to also respond to r.f. activation signal 68 at the frequency generated by wireless remote control transmitter 70-3. Each of wireless remote control transmitters 70-1, 70-2 and 70-3 may be operated, for example, by respective designated personnel from a local or regional police or fire department.

However, in another embodiment, each of wireless remote control transmitters 70-1, 70-2, 70-3 may be functionally identical to wireless remote control transmitter 70-4 such that each of wireless remote control transmitters 70-1, 70-2, 70-3, 70-4 is capable of simultaneously activating all of the plurality of r.f. controlled emergency beacons 86 (e.g., 10-1, 10-2, 10-3, 10-4, 10-5, 10-6, 10-7, 10-8 and 10-9) by generating r.f. activation signal 68 on the same frequency. As such, the entire emergency evacuation beacon system 74 may be activated by receiving the r.f. activation signal 68 from any one of the wireless remote control transmitters 70-1, 70-2, 70-3, 70-4.

As an example of the use of emergency evacuation beacon system 74 during an emergency evacuation situation, each of a plurality of officials has access to at least one of the wireless remote control transmitters 70-1, 70-2, 70-3, 70-4 of the plurality of wireless remote control transmitters 88. The plurality of officials may include, for example, at least two people selected from at least one of a police department, a fire department, a mayor's office, and the Coast Guard, or other government agency or civil defense organization. The plurality of wireless remote control transmitters 88 are configured to individually, or cumulatively, activate each of the plurality of r.f. controlled emergency beacons 86 in an emergency evacuation situation. For example, emergency evacuation beacon system 74 may be configured such that any one wireless remote control transmitter 70-1, 70-2, 70-3, 70-4 of the plurality of wireless remote control transmitters 88 may activate all of the plurality of r.f. controlled emergency beacons 86 in a particular geographic region, e.g., coastal region 72.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An emergency beacon, comprising:
a housing having a first end, a second end, and a side wall extending between the first end and the second end, said housing having a first open space adjacent said first end and a second open space adjacent said second end;
a battery received in said housing;
electronics circuitry received in said housing, said electronics circuitry being electrically coupled to said battery, said electronics circuitry including an r.f. illumination control circuit and a power supply circuit, said r.f. illumination control circuit being configured to receive an r.f. activation signal;
a solar panel electrically coupled to said power supply circuit for charging said battery;
a first closure member received at said first end to close said first open space of said housing;
a second closure member received at said second end to close said second open space of said housing; and
a beacon light source mounted to said second closure member, said second closure member being configured to facilitate an electrical connection between said beacon light source and said r.f. illumination control circuit, said r.f. illumination control circuit being configured to activate said beacon light source to emit light upon receiving said r.f. activation signal.

2. The emergency beacon of claim 1, wherein said first open space is separated from said second open space by a separator wall, said battery being mounted in said first open space and said electronics circuitry being mounted in said second open space, said battery being accessed by removing said first closure member from said housing and said electronics circuitry being accessed by removing said second closure member from said housing.

3. The emergency beacon of claim 1, wherein said first closure member is configured to serve as a base support for mounting said emergency beacon to a secondary structure.

4. The emergency beacon of claim 1, wherein said second closure member includes a base and a transparent cover coupled to said base to define a beacon chamber between said base and said transparent cover, said beacon light source being mounted in said beacon chamber.

5. The emergency beacon of claim 1, further comprising a mounting bracket attached to said side wall for mounting said emergency beacon to a secondary structure.

6. The emergency beacon of claim 1, further comprising a wireless remote control transmitter, said wireless remote control transmitter and said r.f. illumination control circuit being configured to operate on a predetermined frequency, said wireless remote control transmitter generating said r.f. activation signal.

7. The emergency beacon of claim 1, wherein said beacon light source is a stationary multifaceted LED array controlled by said r.f. illumination control circuit to provide a pulsating light output appearance to a human observer.

8. The emergency beacon of claim 1, wherein said beacon light source is a rotating light source controlled by said r.f. illumination control circuit to provide a pulsating light output appearance to a human observer.

9. The emergency beacon of claim 1, wherein said first end of said housing is connected to said first closure member by a first threaded coupling and said second end of said housing is connected to said second closure member by a second threaded coupling, and further comprising a first sealing member interposed between said first end of said housing and said first closure member, and a second sealing member interposed between said second end of said housing and said second closure member.

10. The emergency beacon of claim 1, wherein said side wall is a cylindrical tube, and each of said side wall, said first closure member and said second closure member are comprised of a UV resistant PVC material.

11. An emergency evacuation beacon system for use along a predetermined evacuation route during an evacuation of a geographic region, comprising a plurality of r.f. controlled emergency beacons located along said predetermined evacuation route, each emergency beacon having a respective beacon light source, each emergency beacon of said plurality of r.f. controlled emergency beacons being responsive to an activation signal on a particular predetermined radio frequency to activate said respective beacon light source, and at least two emergency beacons of said plurality of r.f. controlled emergency beacons responding to the same predetermined radio frequency.

12. The emergency evacuation beacon system of claim 11, wherein each of at least a portion of said plurality of r.f. controlled emergency beacons is located at a respective road intersection along said predetermined evacuation route.

13. The emergency evacuation beacon system of claim 11, wherein all of said plurality of r.f. controlled emergency beacons are controlled for actuation by responding to the same predetermined radio frequency.

14. The emergency evacuation beacon system of claim 11, wherein said plurality of r.f. controlled emergency beacons are distributed among a plurality of towns, wherein at least a first wireless remote control transmitter is configured to activate at least a portion of said plurality of r.f. controlled emergency beacons in an emergency evacuation situation.

15. The emergency evacuation beacon system of claim 14, wherein said first wireless remote control transmitter is configured to activate each of said plurality of r.f. controlled emergency beacons.

16. The emergency evacuation beacon system of claim 14, wherein said first wireless remote control transmitter is one of a plurality of wireless remote control transmitters, and each of a plurality of officials has access to at least one wireless remote control transmitter of said plurality of wireless remote control transmitters, wherein said plurality of wireless remote control transmitters are configured to cumulatively activate each of said plurality of r.f. controlled emergency beacons in an emergency evacuation situation.

17. The emergency evacuation beacon system of claim 16, wherein said plurality of officials include at least two people selected from at least one of a police department, a fire department, a mayor's office, and the Coast Guard.

18. The emergency evacuation beacon system of claim 11, wherein each of said plurality of r.f. controlled emergency beacons is mounted on an elevated structure.

19. The emergency evacuation beacon system of claim 11, wherein each emergency beacon of said plurality of r.f. controlled emergency beacons includes:
a waterproof housing;
a rechargeable battery received in said housing;
electronics circuitry received in said housing, said electronics circuitry being electrically coupled to said rechargeable battery, said electronics circuitry including an r.f. illumination control circuit, said r.f. illumination control circuit being configured to receive an r.f. activation signal; and
a beacon light source mounted to housing, said beacon light source being electrically coupled to said r.f. illumination control circuit, said r.f. illumination control circuit being configured to activate said beacon light source to emit light upon receiving said r.f. activation signal.

20. An emergency beacon with remote control, comprising:
a housing;
a rechargeable battery received in said housing;
electronics circuitry received in said housing, said electronics circuitry including a power supply circuit and an r.f. illumination control circuit, said power supply circuit being electrically coupled to said rechargeable battery, and said r.f. illumination control circuit being configured to receive an r.f. activation signal;
a solar panel mounted to an exterior surface of said housing, said solar panel being electrically coupled to said power supply circuit for charging said battery;
a beacon light source mounted to said housing, said beacon light source being electrically coupled to said r.f. illumination control circuit, said r.f. illumination control circuit being configured to activate said beacon light source to emit light upon receiving said r.f. activation signal; and
a wireless remote control transmitter configured to generate said r.f. activation signal, said wireless remote control transmitter being configured to communicate said r.f. activation signal to said r.f. illumination control circuit on a predetermined frequency.
